(19) United States
(12) Patent Application Publication
(10) Pub. No.: US 2024/0417305 A1
(43) Pub. Date: Dec. 19, 2024

(54) Optical Fiber Manufacturing Using Centrifugal Injection Molding in Microgravity

(71) Applicant: Flawless Photonics, Inc., Huntington Beach, CA (US)

(72) Inventors: Michael Vestel, San Francisco, CA (US); Alexander Hallock, Littleton, MA (US)

(21) Appl. No.: 18/667,959

(22) Filed: May 17, 2024

Related U.S. Application Data
(60) Provisional application No. 63/503,159, filed on May 18, 2023.

(51) Int. Cl. C03B 37/04; C03B 37/012

(52) U.S. Cl. CPC C03B 37/041; C03B 37/01265; C03B 2205/08

(57) ABSTRACT

Control apparatus for the formation of a tube (referred to as clad) and subsequent injection of material into the tube (referred to as core) to create a unified product (referred to as preform) while in a microgravity environment. The apparatus permits control of a plurality of key variables during the manufacturing process including heating, cooling, and holding temperature in various parts of the instrument, keeping a precise rotation schedule, maintaining a dry atmosphere, managing any chemical effluent, and ensuring all surfaces are unreactive.

### RELATED APPLICATIONS

This application claims priority to United States Provisional Patent Application Ser. No. 63/503,159 for “Centrifugal Injection Molding in Microgravity,” filed May 18, 2023, and currently co-pending, the entirety of which is fully incorporated herein by reference.

### FIELD OF THE INVENTION

The present invention relates to the manufacture of optical fiber preform out of various materials, the most notable of which is ZBLAN.

### BACKGROUND OF THE INVENTION

Optical fibers can generally be made out of a flexible glass or plastic fiber that can transmit light from one end of the fiber to the other. Typically, optical fibers are used for communication between devices due to its ability to transmit signals over long distances and at higher bandwidths then is possible for a substitute material such as an electrical cable. Each optical fiber that is manufactured is made up by two different layers; a core that is surrounded by a cladding material.

The starting point for any manufacturing process of any kind of optical fiber is the production of preform. Once a suitable preform is made, then the optical fiber can be drawn out in a manner that is consistent with the material used and the design needs of a job. Consequently, because the preform is the starting material for downstream production, it has long been recognized that the purity, refractive index profile, and any other potential defects are of critical importance for preform production.

An optical fiber preform is typically a cylindrical piece of glass which is drawn into optical fiber using a drawing tower. Typical performs tend to be anywhere from 30-400 mm long and cam have a diameter that ranges from a few mm up to several cm. A common industrial size for is between 75 mm and 130 mm long with a diameter of between 5 mm and 12 mm. Additionally, preforms can be constructed out of a number of different materials that includes silica and borosilicate glasses.

One type of glass that is incredibly promising as a material for optical fibers is ZBLAN. ZBLAN is the most stable and most used of the fluoride glasses and is particular suited for optical fibers because of its superior transmittance, higher bandwidth for signal transmission, spectral broadening, and lo chromatic dispersion when compared to silicas currently used. Unfortunately, ZBLAN has a tendency to develop crystalline defects during manufacturing, leading to poor quality products.

The number of undesired defects present in the optical fibers are only increased due to the current manufacturing processes. Different materials used during the manufacturing process of preforms shed microparticles into molten materials, and it is also well known that any oxides present during the heating phase reacts negatively with molten ZBLAN.

### SUMMARY OF THE INVENTION

A promising way to manufacture optical fiber out of ZBLAN is to produce the fiber in a microgravity or reduced gravity environment, so that it is free of any defects. In such a microgravity environment, such as on the International Space Station (ISS), in orbit or partial orbit, or even on the moon, to remove the effect of gravity, the ZBLAN can be processed in a more uniform manner. Local instabilities, such as convection currents and surface tension, are minimized if not effectively eliminated in microgravity. This result in a more perfect ZBLAN preform for use in the development of various downstream fiber products.

Additionally, the present invention focuses on the suppression and near elimination of any defects caused by the manufacturing process. The process includes the use of centrifugal force to make a smooth interface on the inside of the cladding and the use of injection or extrusion into this opening to disrupt that interface as little as possible when filling in the core. It is also of critical importance that all surfaces that come into contact with molten material are inert or coated to be chemically inert so that they are passivated or coated. Finally, the associated heating, cooling, and annealing curves are strictly controlled to prevent any cracking, bubbling, or any other defects from appearing. For example, cooling rates must be slow enough not to crack the glass due to the large thermal expansion coefficient of fluoride materials.

Generally, the process can be followed according to the following steps. First, the cladding materials are melted in a crucible until a glass is formed. Second, the molten glass is drawn into a syringe-like device and then subsequently injected into the rotational casting machine. Third, once the machine begins to spin, the cladding materials are shaped into a cylinder and then slowly annealed. Fourth, the core materials are melted in a crucible until a glass is formed. Fifth, the core glass is drawn into a syringe-like device and is subsequently injected into the cladding material, forming a preform. Sixth, the resulting preform is slowly annealed and the final product can be removed from the machine and drawn into optical fiber through the use of a drawing tower that is typical in the art.

The process outlined in the proceeding paragraph lists the steps generally followed, but there are also other factors that need to be controlled. Once such factor is the immediate atmosphere where the process takes place. When working with ZBLAN the moisture content needs to be as low as possible, this requires the gases to be dried before they are able to flow into the crucible prior to melting. The gasses used also need to be free from any deleterious metal contaminants such as iron, copper, and cobalt.

Another factor that is controlled during the manufacturing process is the outgas and resulting pressure. This is of importance due to the entire manufacturing process being performed in a closed system, so any pressure that builds up needs to be carefully managed. ZBLAN is known to outgas a number of different gasses when it is being melted from solid to liquid. For instance, depending on the composition, surface chemistry, and atmosphere, ZBLAN can outgas zirconium fluoride, hydrogen fluoride, hydrogen chloride, carbon dioxide, and oxygen. Regardless of what is being outgassed, it is critical that it is properly managed.

The final factor that is controlled during the manufacturing process is applying the requisite coatings to any material that comes into contact with the molten ZBLAN. Ensuring a proper coating prevents any micromaterials from being shed because the surfaces will be properly passivated. The coatings that could be used in conjunction with the manufacturing process are varied but include the use of platinum, glassy carbon, or pyrolytic carbon.

What is left after the manufacturing process is followed is ZBLAN preform that is of superior quality to preforms manufactured terrestrially. Critically, this process allows for the development of optical fiber cable that can take full advantage of the benefits associated with ZBLAN. Additionally, this fiber can be produced for use in a wide variety of different industries that includes, but is no limited to, defense, telecommunications, medical devices, and quantum applications.

Accordingly, an object of the invention is to provide apparatus for controlling the heating of starting materials with the ability to hold temperature at a predetermined value.

A further object of the invention is to use centrifugal force to generate a tube with a smooth interior with the ability to precisely control rotation.

A still further object of the invention is to fill the tube with a second liquid material under conditions such that the interface is minimally disturbed.

A still further object of the invention is to anneal the preform on a carefully determined temperature profile to prevent cracking or other deleterious processes.

A still further object of the invention is to keep an inert atmosphere (nitrogen, argon, helium) sufficiently dry so as to prevent unwanted reaction between water and ZBLAN.

A still further object of the invention is to manage any gas emitted by the materials during the process.

A still further object of the invention is to ensure all internal surfaces that come in contact with any material are inert or properly coated so as to be inert.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is an example of a preform that would be produced by this machine;

FIG. 2 is a block diagram outlining the general process followed by the machine;

FIG. 3 is a description of how the instrument is organized. Different embodiments maintain some common design features: the mold needs to be able to spin, molten glass needs to be piped in, all while the atmosphere is carefully controlled;

FIG. 4 Is a detailed view of the tube 200 where the process occurs. The mold 208 where the preform is made is detailed and includes a induction coil capable of controlling the temperature of the tube 200. An inner tube 204 is provided for receiving the core material, and an outer tube 206 is provided for receiving the cladding material. Of particular interest is the core injector which is made from a tube within a tube construction; and

FIG. 5 is an exemplary flow chart identifying a typical method of manufacture of the present invention.

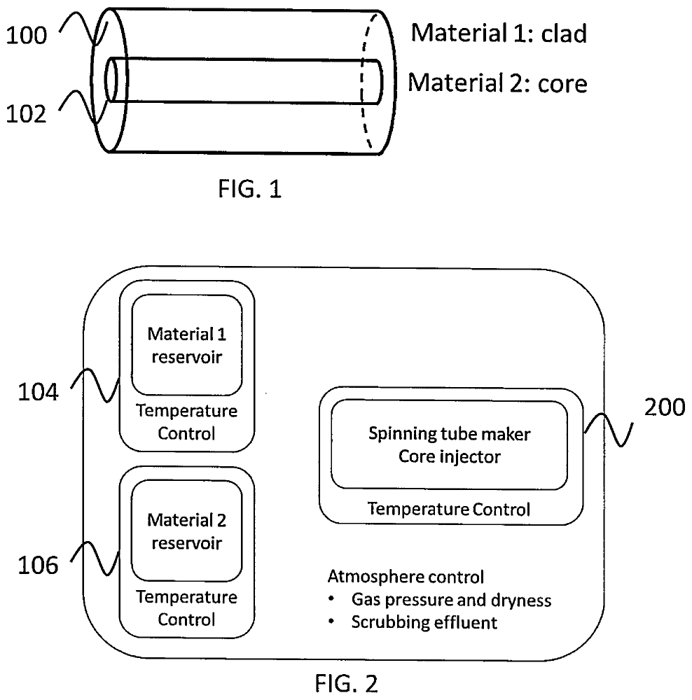

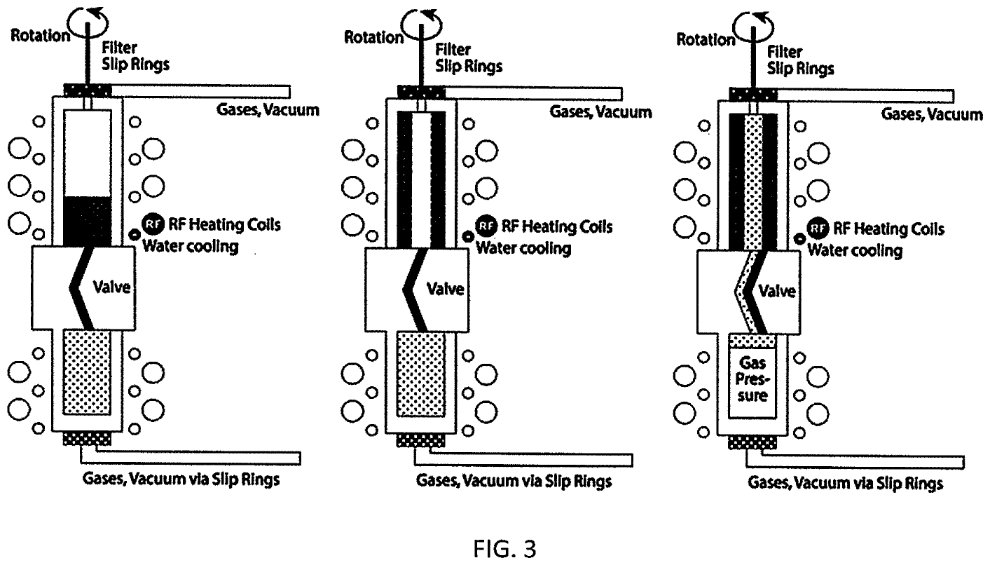

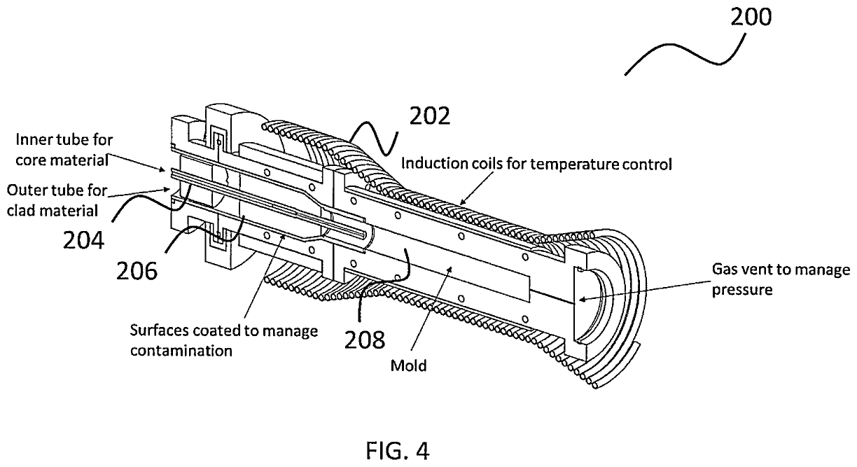

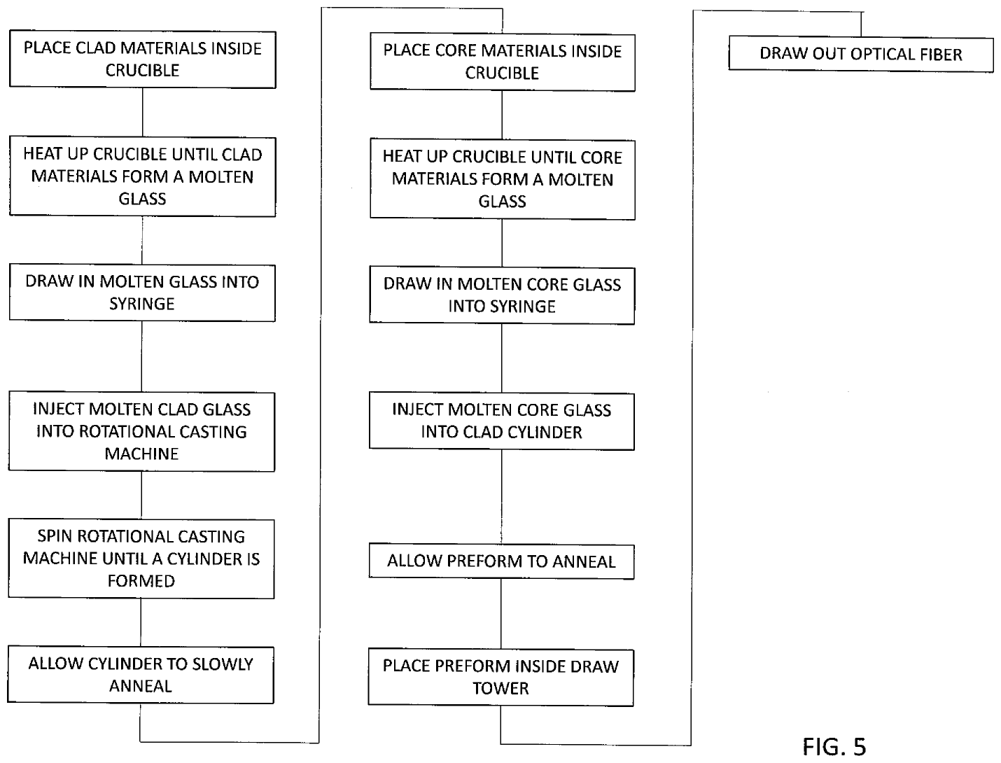

### DETAILED DESCRIPTION

The manufacturing of optical fibers in microgravity of the present invention includes providing one or more molten materials: (1) One embodiment is to have glass billets, tubes or rods, previously fabricated, inside reservoirs that can be heated until the glass is molten and then piped into the mold. (2) An alternative embodiment is to use a pipette, tube, or another ZBLAN tube to draw up molten glass from a crucible, then inject it into the instrument. (3) An alternative embodiment is to have glass starting materials (powders) inside a reservoir that can be heated until molten glass is formed and subsequently piped into the mold or an intermediate reservoir. (4) An alternative embodiment is to have only a single reservoir to provide molten glass for the core-making step. The other glass, which forms the clad, is stored in the crucible itself and is simply heated there to begin the fabrication process

The manufacturing process requires that the glass material needs to be heated to its liquidous temperature and held there long enough to assure complete melting. Material also needs to be kept hot enough to remain liquidous until it is time in the process to solidify.

The making of a tube is accomplished by: (1) Molten glass is piped into the mold chamber and centrifugal force is used to drive molten glass to the wall of a chamber in order to make a tube with the requisite smooth inner interface. A tube could be made by a separate instrument then placed inside the mold using this device only as a core-injection vehicle. (2) Alternatively, a tube could be made by extrusion if the core and clad were simultaneously injected into the mold. In this case, spinning would not be required. (3) As an alternative, core suction may be implemented to make a tube, and extrusion can be used to make a tube or a preform.

Requirements of Tube are that the tube needs to be flat to the right tolerance (typically better than 2% variance in thickness across the length of the preform).

Injecting the core is accomplished with the core material being injected by a plunger (like a syringe), and may be injected by gas pressure. Core material could be filled using a tiny syringe, possibly starting from the far end of the mold with the needle retreating as the glass fills the core region

Requirements of Injection Process include the core material remaining liquid while being injected and needs to be injected fast enough not to cause problems like solidifying early, uneven heating, or warping the interfaces (less than 1 minute).

Annealing the preform occurs with the resulting preform being annealed by passive cooling. This is accomplished by having the mold be of sufficient thermal mass to remove enough heat by diffusion. The rate of heat removal is then controlled by choosing the appropriate heat sink material. The resulting preform could be annealed by active cooling. A TEC (ThermoElectric Cooler), circulator, radiator, or combinations thereof allows for control of the cooling rate. Alternatively, the resulting preform could be annealed by a combination of active and passive cooling to maintain the proper cooling rate.

Requirements for Annealing process include cooling rates from molten to below the glass transition temperature in less than one minute. Preform cannot be allowed to heat up at all during the annealing process.

Controlling the atmosphere is required. When working with ZBLAN, moisture needs to be as low as possible so all gases are dried before they flow into the device and the gases need to be free from deleterious metal contaminants. Of particular note are iron, copper, and cobalt.

Requirements of control include the water to be below 1 ppm, preferably down to 1 ppb (or beyond) where possible.

Managing outgassing is a critical aspect of the manufacturing process, as any material being melted from solid to liquid may outgas and the resulting pressure needs to be managed in a closed system. ZBLAN in particular is known to evolve zirconium fluoride and, depending on composition, surface chemistry, and atmosphere also hydrogen fluoride, hydrogen chloride, carbon dioxide, and oxygen all of which need to be properly contained and managed.

Requirements of Outgassing Process, such as acid gases, must be trapped and stored and/or neutralized. Sublimed metal fluorides need to be trapped. Overpressure needs to be managed to avoid an explosive condition.

Coatings which contact the molten materials must be critically managed as all surfaces in contact with molten materials will shed some amount of material into the melt. In the case of ZBLAN, many common materials will lead to unacceptable contamination. Interior surfaces may be made from or coated with Platinum. Interior surfaces may be made from or coated with glassy carbon. Interior surfaces may be made from or coated with pyrolytic carbon.

Requirements for manufacturing vary for different coatings, and the total transition metal contaminant needs to remain below 100 ppb. Specific metals that interfere with the chosen operational wavelengths (for example Fe, Co, Cu) need to be kept as low as possible.

Concept of Operations: A Process Overview shown in FIG. 5 and described below outlines a clear description of transforming starting materials to finished product using the invention described above.

A glass recipe for both core and clad is chosen based on experience and a large body of existing literature. The starting point is raw powders that are sourced from chemical vendors. Once the powders are delivered, they need to be purified to reduce the number of defects during the manufacturing process. Any number of purification methods known and understood in the chemical community can be used. Some of the processes currently envisioned does include sublimation, solvent extraction, recrystallization, chelation, fluorination, or drying.

The clad materials are melted in a crucible until a glass is formed.

Molten glass is drawn into a syringe-like device, then injected into the rotational casting machine.

The machine spins up forming the glass into a cylinder which is slowly annealed.

The core materials are melted in a crucible until a glass is formed.

Molten glass is drawn into a syringe-like device, then injected into the clad material.

The resulting preform is slowly annealed.

The finished product is now removed from the machine and can be drawn into optical fiber on a typical draw tower.

The resulting fiber then can be examined by a number of known techniques to assess its suitability and provide feedback for the next round of synthesis.

### Additional Alternative Embodiments

A preform is defined as a core/clad structure because that's how it is typically made; however, a preform with additional layers is contemplated, and is not be restricted to two materials. Further, it need not be cylindrical and it need not be concentric.

A preferred embodiment is made from glass, but it is further contemplated that the technique of the present invention is also suitable for use with other materials or even a hybrid with glass in one layer but not another.

We claim:

1. A method of manufacturing an optical fiber in a microgravity environment, comprising the steps of:
combining clad materials in a crucible;
applying heat to said crucible until said clad materials are melted and a molten glass is formed;
drawing said molten glass into a syringe-like device;
injecting said molten glass from said syringe-like device into the rotational casting machine;
spinning said molten glass in said rotational casting machine to form said glass into a cylinder; and
annealing said cylinder for form a fiber clad.

2. The method of claim 1, further comprising:
combining core materials in a crucible;
applying heat to said crucible until said core materials are melted and a molten glass is formed;
drawing said molten glass into a syringe-like device;
injecting said molten glass into said fiber clad to form a preform; and
annealing said preform.

3. The method of claim 2 further comprising drawing said preform into an optical fiber.
